(19) United States
(12) Patent Application Publication
(10) Pub. No.: US 2018/0108114 A1
(43) Pub. Date: Apr. 19, 2018

(54) SELECTIVE SCALING FOR USER DEVICE DISPLAY OUTPUTS

(71) Applicant: Microsoft Technology Licensing, LLC, Redmond, WA (US)

(72) Inventor: Samy Boshra-Riad, Bellevue, WA (US)

(21) Appl. No.: 15/296,596

(22) Filed: Oct. 18, 2016

(51) Int. Cl. G06T 3/40; G09G 5/30; H04N 7/01; G09G 5/00

(52) U.S. Cl. CPC G06T 3/4092; G09G 5/30; G09G 2340/0442; G09G 5/005; H04N 7/0122

(57) ABSTRACT

Dynamic display output scaling techniques for computing systems and user devices are presented herein. In one example, a method of scaling display output for a user device includes, based at least in part on a display device being communicatively coupled to the user device, identifying one or more display properties from the display device. The method includes selecting among target scaling processes for a display output of the user device based at least on processing the one or more display properties against a display record, scaling the display output in accordance with at least a selected target scaling process, and transferring the display output for display on the display device.

### BACKGROUND

Various electronic user systems, such as computers, gaming systems, and media players, can establish graphics/video outputs for displays and other video systems. For example, a computing system can provide various graphical user interface elements to a video monitor that displays the graphical user interface elements to a user. Gaming systems can interface with monitors, televisions, or virtual reality displays, among others. These user systems include video processor elements, such as graphics cards, graphics processing cores, as well as various interface circuitry and connectors. Many times, the video processor elements can support different display resolutions. Additionally, the various displays, televisions, and monitors can support one or more resolutions, with digital displays typically having a native or preferred resolution. As displays become more advanced and support higher display resolutions, meshing output resolutions of the user devices to the various displays has become increasingly difficult.

### Overview

Dynamic display output scaling techniques for computing systems and user devices are presented herein. In one example, a method of scaling display output for a user device includes, based at least in part on a display device being communicatively coupled to the user device, identifying one or more display properties from the display device. The method includes selecting among target scaling processes for a display output of the user device based at least on processing the one or more display properties against a display record, scaling the display output in accordance with at least a selected target scaling process, and transferring the display output for display on the display device.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a device video scaling environment in an implementation.

FIG. 2 illustrates operation of a video scaling environment in an implementation.

FIG. 3 illustrates a device video scaling environment in an implementation.

FIG. 4 illustrates example scaling data records of a device video scaling control environment in an implementation.

### DETAILED DESCRIPTION

End user systems, such as computing devices, set-top boxes, gaming systems, entertainment devices, and the like, can include display output capabilities to allow a user to interface with graphical elements, graphical user interfaces, and view media content. The display outputs can be coupled to associated display devices, such as a video monitor, television, or provided over network links or virtualized links. However, most external displays have either native resolutions or maximum resolutions for displaying graphical images or data.

Due to differences between the maximum supported resolutions by a display device, such as a television, and the resolution for video rendered by a user device or user system, video scaling might be employed to provide the user with an improved viewing experience or for optimal rendering of video on a display device. For example, when the end user device is a gaming system coupled to a television, matching the display output resolution of the gaming system to the native or maximum resolution of the television can be challenging. Scaling a display output from a native resolution of generated graphics can provide a better user viewing experience in some cases.

However, many video monitors and televisions can include scaling features apart from the user devices. In some cases, a user might have a better viewing experience when scaling features of the external display device are employed. Scaling quality differs between different video monitors and televisions (TVs) and also between various user devices that can perform scaling. A user device can select to always perform internal scaling or to always rely upon an external display for scaling. However, the examples herein can provide a dynamic scaling process so that individual video displays can have a more optimal experience for users and video rendering. The dynamic scaling processes discussed herein can maintain a customized scaling process for each individual video display encountered by a user device.

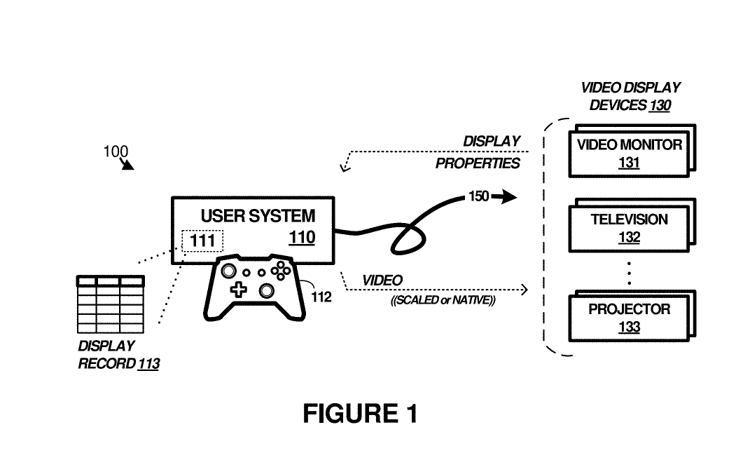

As a first example, FIG. 1 is provided. FIG. 1 illustrates a dynamic scaling environment 100 in an implementation. Environment 100 includes user system 110 which can be coupled to various video display devices 130. User system 110 can communicatively couple to video display device over link 150. User system 110 includes scaling service 111 and user interface device 112.

In operation, a user couples user system 110 to any selected video display device 130, such as any among video monitors 131, televisions 132, or projectors 133, among other display devices or display systems, including combinations thereof. Scaling service 111 in user system 110 can detect the display type, among other properties of the displays, and dynamically select a scaling process for use with display output for the user device. Advantageously, various enhanced technical effects include providing users with a better video experience that includes an enhanced rendering of video onto a display device. Moreover, graphical user interfaces can be more faithfully rendered on a selected display, and more efficient usage of scaling resources of user systems and display devices can be achieved.

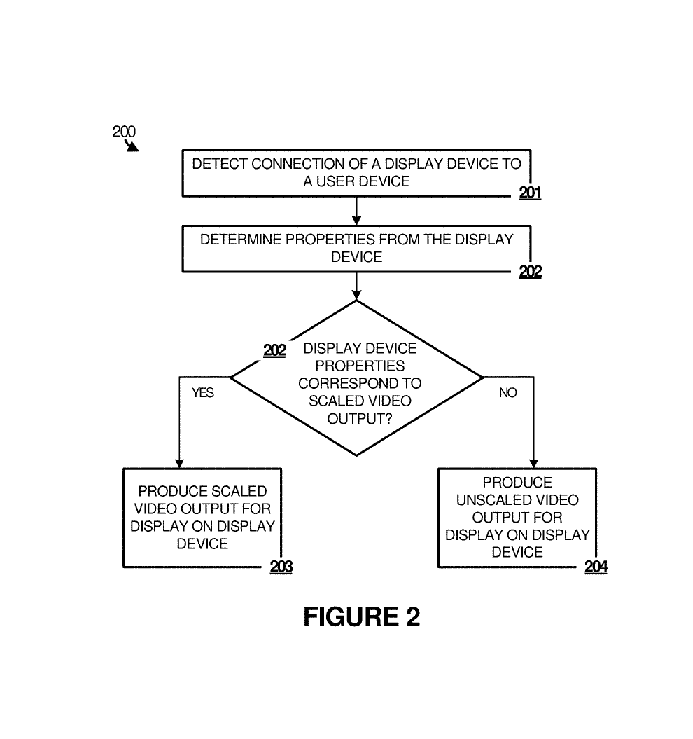

To further illustrate the operations of elements of environment 100, FIG. 2 is provided. In FIG. 2, user system 110 detects (201) connection of a display device to a user device. For example, user system 110 can detect when any video display device 130 is coupled over link 150, which might include a physical coupling or connecting of a cable or an initiation of a wireless or optical connection to a display output of user device 110.

Based at least in part on this connection or coupling, user system 110 determines (202) properties from the display device. These properties can be requested, read, or otherwise provided by the display device to user system 110, such as over link 150. These properties can include display model information, display type information, display descriptors, display identifiers, supported display resolutions, status information, display settings, color gamut information, or other information, including combinations thereof. In some examples, such as when link 150 carries High-Definition Multimedia Interface (HDMI) or DisplayPort links, the properties can include Extended Display Identification Data (EDID). EDID includes data structures provided by a coupled digital display to describe associated capabilities to a display source, such as user system 110. EDID can indicate various properties of the display device, such as display make and model, display manufacturer name, display product codes, display year-of-manufacture, serial numbers, or other display identifiers or display identities.

User system 110 selects among target scaling processes for a display output of user device 110 based at least on processing the one or more display properties against a display record. The display record can comprise one or more data structures, such as tables, databases, and the like, that correlate display properties to target scaling processes. In FIG. 1, display record 113 is shown that indicates these correlations in one example implementation. It should be understood that other data records and display records can be employed, including locally-stored and remotely-stored data records.

To determine which scaling process is to be employed, a number of display devices are included in associated entries in display record 113 that indicate a preferred scaling process, including if no scaling is preferred. A default scaling process can be indicated for display devices not yet indicated in display record 113. Display record 113 can be established by a user of user system 110, a manufacturer of user system 110, or altered during operation/testing of user system 110 based on various factors including software updates, display make/model additions, display testing results, software or hardware updates to user system 110 that alter native resolutions of user system 110, or other factors.

The display records can be organized according to the properties of the various displays to which user system 110 can be coupled. For example, the display records can have a first column indicating makes and/or models of display devices. A second column can indicate a preferred scaling process for the associated display devices, such as providing an ‘upscaled’ output, a ‘downscaled’ output, or ‘no scaling’ of the output which is provided over link 150. In ‘no scaling’ examples, user system 110 might rely upon display scaling features of the connected display device. Further columns can be indicated for further discrimination or selection among display devices based on other factors, such as serial numbers, link type, sub-distinctions among make/model designations, or other factors. Additionally, more detailed scaling selections can be provided, such as by indicating specific scaling algorithms, scaling functions, or scaling parameters.

In one example, user system 110 determines when the display device properties correspond to a scaled display output (203) or an unscaled display output (204). This determination is dynamic responsive to coupling of the display device to user system 110, and thus different display devices can have different scaling processes applied thereto. User system 110 can either produce (203) a scaled display output for display on display device, or produce (204) an unscaled display output for display on display device. The scaled display output can include upscaling, downscaling, or other scaling factors and processes.

In a specific example, the scaled display output is an upscaled display output. Upscaling produces a higher resolution output based on an upscaling process applied to video/graphics in an input resolution. This upscaling process can employ various algorithms or functions to derive a higher resolution output than natively provided as an input to the upscaling process. A pixel doubling algorithm can be employed, or various interpolation functions can be employed to produce a desired output resolution. For example, a native or internal resolution for graphics/video of user system 110 might be “high definition” or HD at 1,920×1,080 pixels (referred to as 1080p), among other resolutions. A display device might have a desired or native resolution of 4096×2160 pixels (referred to as 4k) or 7,680×4,320 pixels (referred to as 8k). Thus, an upscaling process can be employed to scale the 1,920×1,080 pixels produced by an HD graphics subsystem of user system 110 to the 4096×2160 pixels of a 4k display device. As mentioned herein, at times the specific display device might have sufficient upscaling features and user system 110 can output the unscaled or native graphics over link 150 for upscaling by the display device. In other examples, user system 110 might have superior upscaling features, and user system 110 can produce the upscaled output for transfer over link 150. Once the selected scaling process has been applied, then user system 110 transfers the display output for display on the display device.

Returning to a discussion of the elements of FIG. 1, user system 110 comprises an end user system, such as gaming systems, terminals, computing devices, tablet devices, smartphones, personal computers, servers, cloud-based systems, distributed computing platforms, and the like. Users, such as users of a gaming system, entertainment platform, computing system can interact with user interface elements of user system 110 via user interface device 112 or other user interface elements. User system 110 can include processing systems, memory systems, network interface equipment, user interface elements, audio and graphics processing systems, video handling systems, as well as video scaling services, such as scaling service 111.

Scaling service 111 determines and applies a dynamic scaling process to graphics or video generated by user system 110. Scaling service 111 comprises one or more execution elements which provide video scaling features for graphics or video generated by user system 110 in a graphics or video processing portion of user system 110. Scaling service 111 can include hardware and software elements, such as video processors, graphics cores, video cards, graphics interface cards, video memory, scaling hardware and software elements, graphics engines, scaling engines, execution units, rendering units, memory interface units, or other elements, including combinations and variations thereof. In many examples, scaling service 111 is employed to selectively scale graphics or video of a multitasking or multithreaded operating environment for user applications, gaming applications, productivity applications, entertainment applications, or other software elements.

User interface device 112 receives user input from various input devices, such as one or more gaming controllers, keyboards, mouse devices, touch screens, touch panels, or other user input devices which can be used in combination with voice input, visual input, or other user input methods. This user input can be detected by user system 110 and translated into actions which can be interpreted by further elements of user system 110, such as scaling service 111.

Video display devices 130 can each comprise video monitors, televisions, projectors, touchscreens, transported video interfaces, virtualized interfaces, or other video or graphics viewing elements, including combinations thereof. Each display device can have one or more input interfaces for receiving graphics or video from a source, such as from user system 110 over link 150. Some examples of video display devices 130 can include video or graphics scaling features in addition to those of user system 110.

Link 150 can comprise one or more communication links, such as one or more video links comprising wireless or wired links. Link 150 can comprise various logical, physical, or application programming interfaces. Example links can use metal, glass, optical, air, space, or some other material as the transport media. Link 150 can use various video protocols and formats, such as High-Definition Multimedia Interface (HDMI), Video Electronics Standards Association DisplayPort, Digital Visual Interface (DVI), Wireless Display (WiDi), Miracast, Video Graphics Array (VGA) interfaces, wireless display interfaces, or other digital and analog video links including interface types that are transported over other types of links. In some examples, video data can be transported over link 150 using various data protocols, such as Internet Protocol (IP), Ethernet, hybrid fiber-coax (HFC), WiFi (IEEE 802.11), Bluetooth, other wired or wireless data interfaces, or some other communication format, including combinations, improvements, or variations thereof. Link 150 can include direct links or may include intermediate networks, systems, or devices, and can include a logical network link transported over multiple physical links. Link 150 can include routers, switches, bridges, traffic handling nodes, and the like for transporting traffic among endpoints.

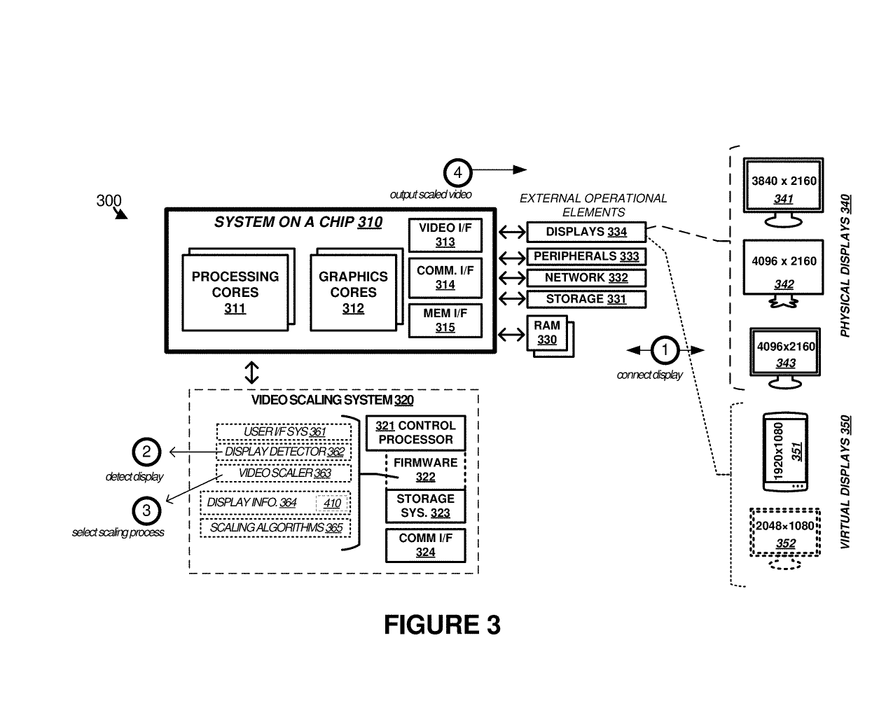

As a further example of display scaling techniques and implementations, FIG. 3 is provided. FIG. 3 is a system diagram illustrating display scaling environment 300. Environment 300 includes a system-on-a-chip (SoC) element along with other associated elements. Specifically, environment 300 includes SoC 310, video scaling system 320, external operational elements 330-334, physical displays 340, and virtual displays 341. SoC 310 further includes internal operational elements 311-315 comprising processing cores 311, graphics cores 312, video interface 313, communication interfaces 315, and memory interface 315. Video scaling system 320 includes control processor 321, firmware 322, storage system 323, and communication interface 324.

Video scaling system 320 can communicate with any of the elements of FIG. 3, such as SoC 310, external operational elements 330-334, internal operational elements 311-315, and display devices 340-350. External operational elements 330-334 can communicate with SoC 310 over associated communication interfaces, and can receive power from associated power subsystems. SoC 310 and associated internal operational elements 311-315 can communicate internally over associated busses and communication interfaces, and can receive power over associated power links.

Taking the example where elements of environment 300 comprise a gaming system or entertainment device (such as a gaming console) a user can couple the example gaming system to a selected display device. This selected display device can include any number of physical monitors, televisions, projectors, or might include virtualized or networked display systems. Various example display devices physical displays 341-343 and virtual displays 351-352 are shown in FIG. 3. These display devices can couple through associated links to video interface 313 of SoC 310, which can include associated connectors, cabling, interface electronics, and other circuitry.

Each display can have a different associated native display resolution, such as in liquid crystal (LCD) displays or organic light-emitting diode (OLED) displays, among others. This native display resolution of the display can also correspond to a number of pixels that are present in the display for rendering graphics/video. However, SoC 310 might have a resolution associated with output from a game, user application, operating system, or other software element which is used when rendering graphics for display by graphics cores 312. The resolution of the display and the resolution of the user application might not match, and commonly the resolution of the user application is lower than the native resolution of the display. For example, a native or internal resolution for graphics/video of SoC 310 might be “high definition” or HD at 1,920×1,080 pixels (referred to as 1080p), among other resolutions. A connected display might have a desired or native resolution of 4096×2160 pixels (referred to as 4k) or higher. Thus, an upscaling process can be employed to scale the 1,920×1,080 pixels produced by graphics cores 312 to the 4096×2160 pixels of a 4k display.

Turning now to the operation of environment 300, display detector 362 detects connection or initiation of display device to SoC 310. For example, display detector 362 can detect when any physical video display device is coupled over an associated display link, which might include a physical coupling or connecting of a cable. Display detector 362 can also detect initiation of a wireless or optical connection to a display output of SoC 310. In further examples, display detector 362 can detect initiation of a virtualized display device, such as in virtualized operating environments controlled by a hypervisor, or when a user application streams or ‘casts’ video to a corresponding display device.

Based at least in part on initiation of this display connection or coupling, display detector 362 determines properties from the display device. These properties can be requested, read, or otherwise provided by the display device to display detector 362, such as over a display link. In virtual display examples, various software or hardware elements associated with initiating the virtual displays can provide these properties to display detector 362. These properties can include display make/model information, display type information, display descriptors, display identifiers, supported display resolutions, status information, display settings, color gamut information, or other information, including combinations thereof. In some examples, such as when a display link comprises HDMI or DisplayPort links, the properties can include Extended Display Identification Data (EDID). As mentioned above, EDID includes data structures provided by a coupled digital display to describe associated capabilities to a display source, such as SoC 310. EDID can indicate various properties of the display device, such as display make and model, display manufacturer name, display product codes, display year-of-manufacture, serial numbers, or other display identifiers or display identities.

Video scaler 363 selects among target scaling processes for a display output of SoC 310 based at least on processing the one or more display properties against display information 364 and scaling algorithms 365. Video scaler 363 selects among the number of display devices included in associated entries in display information 364 that indicate a preferred scaling process, including if no scaling is preferred. Display information 364 can comprise one or more data structures, such as tables, databases, and the like, that correlate display properties to target scaling processes.

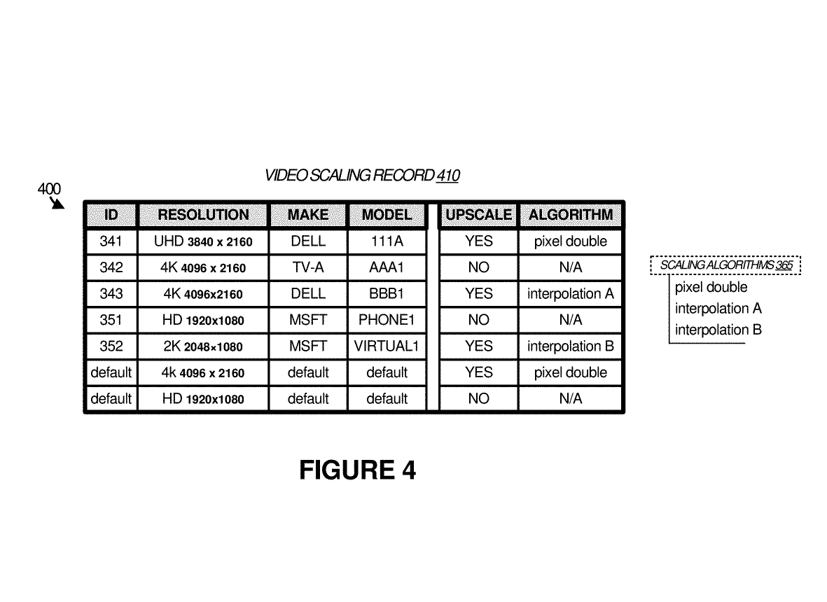

In FIG. 4, video scaling record 410 is shown that indicates these correlations in one example implementation. It should be understood that other data records and display records can be employed, including locally-stored and remotely-stored data records. Video scaling record 410 can be established by a user of SoC 310, a manufacturer of SoC 310 or an associated system, or altered during operation/testing of SoC 310 based on various factors including software updates, display make/model additions, display testing results, software or hardware updates to SoC 310 that change graphical resolutions of user applications, or other factors.

Video scaling record 410 indicates a listing of various displays (referenced to displays shown in FIG. 3) with properties of the displays and selected scaling processes indicated as well. For each display, display resolution is indicated along with make/model indicators. For virtual display, other designators can be indicated in the make/model indicators other than manufacturer names and model numbers, and these designators can be customized to the virtual display type. Moreover, several default displays are included to indicate scaling properties for display types not already indicated in record 410. Record 410 also indicates preferred upscaling indicators (yes/no) and preferred scaling algorithms from among a selection of algorithms that can be included among scaling algorithms 365 of FIG. 3.

Video scaler 363 determines when the display properties correspond to a scaled display output or an unscaled display output, as well as selected scaling algorithms. In record 410, for example, display 341 corresponds to an upscaled process having a pixel doubling algorithm. In another example, display 342 corresponds to a non-upscaled process. In the non-upscaled process, video scaler 363 can rely upon a video scaler feature of the associated display, such as when a video scaler integrated into display 342 is preferred over the video scaler associated with SoC 310. This determination is dynamic and based at least in part on coupling or initiation of a display to SoC 310, and thus different display devices can have different scaling processes applied thereto. Video scaler 363 can either produce an upscaled display output for display on a display, or produce an unscaled display output for display on a display.

In a first example, a user couples display 341 to video interface 313, and display detector 362 detects this display being connected. Display detector 362 retrieves EDID information from display 341 over an associated display interface and extracts properties/information from the EDID to determine which display is connected and corresponding scaling preferences from display information 364 or record 410. In this example, display 341 corresponds to a 4k display that has upscaling preferred using the ‘pixel doubling’ scaling algorithm. Video scaler 363 generates upscaled video for transfer to display 341. The upscaled video increases a pixel quantity from a base resolution of graphics/video generated by software of SoC 310 or by graphics cores 312 of SoC 310.

In a second example, a user couples display 351 to video interface 313, and display detector 362 detects this display being initiated. In this example, display 351 comprises a virtual display on a smartphone, such as over a network link or ‘casted’ video link. Using properties determined for display 351, such as by retrieving display properties associated with display 351, an associated device that hosts display 351, or the virtual system that initiates display 351, display detector 362 can discover an entry in record 410 that corresponds to display 351. In this example, display 351 corresponds to an HD display that has no upscaling preferred. Video scaler 363 provides non-upscaled video for transfer to display 351. The non-upscaled video maintains a pixel quantity from a base resolution of graphics/video generated by software of SoC 310 or by graphics cores 312 of SoC 310.

In a third example, a user couples display 343 to video interface 313, and display detector 362 detects this display being connected. Display detector 362 retrieves EDID information from display 343 over an associated display interface and extracts properties/information from the EDID to determine which display is connected and corresponding scaling preferences from display information 364 or record 410. In this example, display 343 corresponds to a 4k display that has upscaling preferred using the ‘interpolation A’ scaling algorithm. Video scaler 363 generates upscaled video for transfer to display 343. The upscaled video increases a pixel quantity from a base resolution of graphics/video generated by software of SoC 310 or by graphics cores 312 of SoC 310.

Thus, a user can couple various display devices or initiate various virtual displays and have associated video/graphics rendered in a preferred fashion on the associated display. Based on a data record indicating scaling preferences for a predetermined set of displays, video scaler 363 can apply a scaling process to a display output of SoC 310 or an associated user system. The display can be automatically detected and the scaling process dynamically applied according to the detected display. When a detected display includes upscaling function that might be preferred, video scaler 363 can allow that display to perform the upscaling process on unadulterated video/graphics generated by graphics cores 312 or software elements of SoC 310. Advantageously, various enhanced technical effects include providing users with an optimized video experience that includes an enhanced rendering of video and graphical elements onto a display device. Moreover, graphical user interfaces can be more clearly rendered on a selected display when upscaling is desired, and more efficient usage among scaling resources of user systems and display devices can be achieved.

Returning to a discussion of the elements of FIG. 3, video scaling system 320 illustrates a control system that is representative of any system or collection of systems in which the various operational architectures, scenarios, and processes disclosed herein may be implemented. For example, video scaling system 320 can be used to implement any of the control elements of FIG. 1, such as scaling service 111.

Video scaling system 320 can be implemented by various elements that include, but are not limited to, graphics processing subsystems, graphics controllers, graphics cards, or graphics cores of computers, gaming systems, smartphones, laptop computers, tablet computers, desktop computers, server computers, hybrid computers, rack servers, web servers, cloud computing platforms, and data center equipment, as well as any other type of physical or virtual machine, and other computing systems and devices, as well as any variation or combination thereof. Video scaling system 320 may be implemented as a single apparatus, system, or device or may be implemented in a distributed manner as multiple apparatuses, systems, or devices. Video scaling system 320 includes, but is not limited to, control processor 321, firmware 322, storage system 323, and communication interface 324. Control processor 321 is operatively coupled with storage system 323 and communication interface system 324.

Control processor 321 loads and executes firmware 322 from storage system 323. Firmware 322 includes user interface system 361, display detector 362, video scaler 363, display information 364, and scaling algorithms 365 which are representative of the processes, services, and platforms discussed with respect to the preceding Figures. Display information 364 comprises data structures that hold various data associated with operations of firmware 322.

When executed by control processor 321 to provide enhanced video/graphics scaling services, among other services, firmware 322 directs control processor 321 to operate as described herein for at least the various processes, operational scenarios, and sequences discussed in the foregoing implementations. Video scaling system 320 may optionally include additional devices, features, or functionality not discussed for purposes of brevity.

Referring still to FIG. 3, control processor 321 may comprise a micro-processor and processing circuitry that retrieves and executes firmware 322 from storage system 323. Control processor 321 may be implemented within a single processing device, but may also be distributed across multiple processing devices or sub-systems that cooperate in executing program instructions. Examples of control processor 321 include general purpose central processing units, application specific processors, and logic devices, as well as any other type of processing device, combinations, or variations thereof.

Storage system 323 may comprise any computer readable storage media readable by control processor 321 and capable of storing firmware 322. Storage system 323 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 323 may also include computer readable communication media over which at least some of firmware 322 may be communicated internally or externally. Storage system 323 may be implemented as a single storage device, but may also be implemented across multiple storage devices or sub-systems co-located or distributed relative to each other. Storage system 323 may comprise additional elements, such as a controller, capable of communicating with control processor 321 or possibly other systems.

Firmware 322 may be implemented in program instructions and among other functions may, when executed by control processor 321, direct control processor 321 to operate as described with respect to the various operational scenarios, sequences, and processes illustrated herein. For example, firmware 322 may include program instructions for implementing enhanced video/graphics scaling services, among other services.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Firmware 322 may include additional processes, programs, or components, such as operating system software or other application software, in addition to or that including user interface system 361, display detector 362, video scaler 363, display information 364, and scaling algorithms 365. Firmware 322 may also comprise firmware or some other form of machine-readable processing instructions executable by control processor 321.

In general, firmware 322 may, when loaded into control processor 321 and executed, transform a suitable apparatus, system, or device (of which video scaling system 320 is representative) overall from a general-purpose computing system into a special-purpose computing system customized to provide enhanced video/graphics scaling services, among other services. Indeed, encoding firmware 322 on storage system 323 may transform the physical structure of storage system 323. The specific transformation of the physical structure may depend on various factors in different implementations of this description. Examples of such factors may include, but are not limited to, the technology used to implement the storage media of storage system 323 and whether the computer-storage media are characterized as primary or secondary storage, as well as other factors.

For example, if the computer readable storage media are implemented as semiconductor-based memory, firmware 322 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Turning now to the elements of firmware 322, user interface system 361 provides various entry and modification user interface elements for initiating and altering contents of display information 364. Display information 364 includes one or more data structures relating identifiers for display devices to preferred or selected scaling processes. Display detector 362 detects when a display is connected or a display interface is initiated and can determine properties about the display, such as type, make/model, associated resolutions, or other properties. Video scaler 363 handles selecting scaling processes from among display information 364 and performing any associated video/graphics scaling. In some examples, video scaler 363 initiates a scaling process through hardware or software elements related to a graphics core(s) or graphics processor of SoC 310, such as graphics cores 312.

One or more scaling algorithms 365 can be employed for scaling the video/graphics, and related information, executable code, scripts, or other data can be stored for use in scaling processes. Example scaling algorithms include pixel doubling algorithms, where pixels are replicated to increase a quantity of pixels. Example scaling algorithms include pixel interpolation, where adjacent pixels are mathematically interpolated using one or more interpolation functions to increase a quality of pixels. In FIG. 4, three example scaling algorithms are shown, namely “pixel double,” “interpolation A,” and “interpolation B,” although these are merely exemplary.

User interface system 361 provides for user input and output related to configuring the scaling operations of SoC 310. User interface system 361 can receive input and provide output over a programming interface, and can be carried over communication interface 324. User interface system 361 can comprise an application programming interface (API), or other programing interfaces. However, it should be understood that other user interface systems can be provided, such as for control of SoC 310, or applications, games, or platforms executed by SoC 310. In network examples, a user interface system might include web interfaces and terminal interfaces. A user interface system can packetize display or graphics data for remote display by a display system or computing system coupled over one or more network interfaces or web interfaces. Physical or logical elements of user interface systems can provide alerts or visual outputs to users or other operators. User interface systems may also include associated user interface software executable by control processor 321 in support of the various user input and output operations discussed above. Separately or in conjunction with each other and other hardware and software elements, the user interface software and user interface devices may support a graphical user interface, a natural user interface, or any other type of user interface. In further examples, user interface systems may interface with an operator via a gaming controller, touchscreen, keyboard, mouse, voice input device, audio input device, or other touch input device for receiving input from a user. Output devices such as a display, speakers, web interfaces, terminal interfaces, and other types of output devices may also be interfaced by a user interface system.

Communication interface 324 may include communication connections and devices that allow for communication with various operational elements, user interfaces, SoC devices, display interfaces, display devices, or communication networks. Examples of connections and devices that together allow for inter-system communication may include system management interfaces, network interfaces, network interface cards, communication busses, antennas, RF circuitry, transceivers, and other communication circuitry. The connections and devices may communicate over communication media to exchange communications with other computing systems or networks of systems, such as metal, glass, air, or any other suitable communication media.

Communication between video scaling system 320 and other computing systems, such as display devices, operator systems, or end user terminals, may occur over a video or display interfaces, which can be transported over any communication network or networks and in accordance with various communication protocols, combinations of protocols, or variations thereof. Example display interfaces include High-Definition Multimedia Interface (HDMI), Video Electronics Standards Association DisplayPort, Digital Visual Interface (DVI), Wireless Display (WiDi), Miracast, Video Graphics Array (VGA) interfaces, wireless display interfaces, or other digital or analog video links. Example networks include intranets, internets, the Internet, local area networks, wide area networks, wireless networks, wired networks, virtual networks, software defined networks, data center buses, computing backplanes, or any other type of network, combination of network, or variation thereof. Some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

### Example 1

A method of scaling video from a user device, the method comprising, based at least in part on a display device being communicatively coupled to the user device, identifying one or more display properties from the display device. The method includes selecting among target scaling processes for a display output of the user device based at least on processing the one or more display properties against a display record, scaling the display output in accordance with at least a selected dynamic scaling process, and transferring the display output for display on the display device.

### Example 2

The method of Example 1, further comprising identifying the one or more display properties from the display device by at least retrieving the one or more display properties over a communication link that communicatively couples the user device and the display device.

### Example 3

The method of Examples 1-2, where the one or more display properties are indicated in Extended Display Identification Data (EDID).

### Example 4

The method of Examples 1-3, further comprising processing the one or more display properties against the display record by at least comparing a display device identity received from the display device against the display record comprising a plurality of display device identities correlated to preferred target scaling processes.

### Example 5

The method of Examples 1-4, further comprising selecting among the target scaling processes by at least selecting among at least one of an upscaling process and an upscaling algorithm.

### Example 6

The method of Examples 1-5, where selecting among the target scaling processes comprises selecting among an upscaling process performed in the user device and an upscaling process performed in the display device.

### Example 7

The method of Examples 1-6, where the selected target scaling process comprises an upscaling process performed in the user device that upscales video data generated at a base resolution in the user device to an upscaled resolution for transfer as the display output, where the upscaled resolution comprises a greater resolution than the base resolution.

### Example 8

The method of Examples 1-7, where the selected target scaling process comprises an upscaling process performed in the user device that upscales video data generated at a base resolution using a selected scaling algorithm associated in the display record with the one or more display properties.

### Example 9

The method of Examples 1-8, where the display record comprises correlations between display identities and the target scaling processes selected among one or more of an upscaling via a pixel duplication process in the user device, an upscaling via a pixel interpolation process in the user device, and no upscaling in the user device.

### Example 10

A video scaling system for a user device, comprising a video interface configured to identify one or more display properties from a display device based at least in part on the display device being communicatively coupled to the user device. The video scaling system includes a video processor configured to select among target scaling processes for a display output of the user device based at least on processing the one or more display properties against a display record. The video processor is configured to scale the display output in accordance with at least a selected target scaling process, and the video interface configured to transfer the display output for display on the display device.

### Example 11

The video scaling system of Example 10, comprising the video interface configured to identify the one or more display properties from the display device by at least retrieving the one or more display properties over a communication link that communicatively couples the user device and the display device.

### Example 12

The video scaling system of Examples 10-11, where the one or more display properties are indicated in Extended Display Identification Data (EDID).

### Example 13

The video scaling system of Examples 10-12, comprising the video processor configured to process the one or more display properties against the display record by at least comparing a display device identity received from the display device against the display record comprising a plurality of display device identities correlated to preferred target scaling processes.

### Example 14

The video scaling system of Examples 10-13, comprising the video processor configured to select among the target scaling processes by at least selecting among at least one of an upscaling process and an upscaling algorithm.

### Example 15

The video scaling system of Examples 10-14, comprising the video processor configured to select among the target scaling processes by at least selecting among an upscaling process performed in the user device and an upscaling process performed in the display device.

### Example 16

The video scaling system of Examples 10-15, where the selected target scaling process comprises an upscaling process performed in the user device that upscales video data generated at a base resolution in the user device to an upscaled resolution for transfer as the display output, where the upscaled resolution comprises a greater resolution than the base resolution.

### Example 17

The video scaling system of Examples 10-16, where the selected target scaling process comprises an upscaling process performed in the user device that upscales video data generated at a base resolution using a selected scaling algorithm associated in the display record with the one or more display properties.

### Example 18

The video scaling system of Examples 10-17, comprising the video processor configured to maintain the display record comprising correlations between display identities and the target scaling processes selected among one or more of an upscaling via a pixel duplication process in the user device, an upscaling via a pixel interpolation process in the user device, and no upscaling in the user device.

### Example 19

A display output control apparatus for a user device, comprising one or more computer readable storage media, a processing system operatively coupled with the one or more computer readable storage media, and a video scaling service comprising program instructions stored on the one or more computer readable storage media. When read and executed by the processing system, direct the processing system to at least, based at least in part on a display device being communicatively coupled to the user device, identify one or more display properties from the display device. The program instructions further direct the processing system to select among target scaling processes for a display output of the user device based at least on processing the one or more display properties against a display record, scale the display output in accordance with at least a selected target scaling process, and transfer the display output for display on the display device.

### Example 20

The display output control apparatus of Example 19, comprising further program instructions, when executed by the processing system, direct the processing system to at least identify the one or more display properties from the display device by at least retrieving the one or more display properties over a communication link that communicatively couples the user device and the display device, where the one or more display properties are indicated in Extended Display Identification Data (EDID). The program instructions further direct the processing system to select among the target scaling processes by at least selecting among an upscaling process performed in the user device and an upscaling process performed in the display device.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

It should be noted that the term ‘video’ and ‘graphics’ are employed herein, and these can refer to moving and non-moving images, multimedia, graphics, graphical user interfaces, gaming interfaces, productivity interfaces, or other graphical elements for display to a user. Moreover, the video or graphics are typically rendered in a digital format for display on a digital display. However, the techniques and processes discussed herein are not limited to digital video and graphics, and instead can apply to analog displays and graphical data converted from a digital format into an analog format.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the subject matter of this application. Those skilled in the art will also appreciate that the features described above can be combined in various ways to form multiple implementations. As a result, the invention is not limited to the specific implementations described above, but only by the claims and their equivalents.

What is claimed is:

1. A method of scaling a display output from a user device, the method comprising:
based at least in part on a display device being communicatively coupled to the user device, identifying one or more display properties from the display device;
selecting among target scaling processes for the display output of the user device based at least on processing the one or more display properties against a display record;
scaling the display output in accordance with at least a selected dynamic scaling process; and
transferring the display output for display on the display device.

2. The method of claim 1, further comprising:
identifying the one or more display properties from the display device by at least retrieving the one or more display properties over a communication link that communicatively couples the user device and the display device.

3. The method of claim 2, wherein the one or more display properties are indicated in Extended Display Identification Data (EDID).

4. The method of claim 1, further comprising:
processing the one or more display properties against the display record by at least comparing a display device identity received from the display device against the display record comprising a plurality of display device identities correlated to preferred target scaling processes.

5. The method of claim 1, further comprising:
selecting among the target scaling processes by at least selecting among at least one of an upscaling process and an upscaling algorithm.

6. The method of claim 1, wherein selecting among the target scaling processes comprises selecting among an upscaling process performed in the user device and an upscaling process performed in the display device.

7. The method of claim 1, wherein the selected target scaling process comprises an upscaling process performed in the user device that upscales video data generated at a base resolution in the user device to an upscaled resolution for transfer as the display output, wherein the upscaled resolution comprises a greater resolution than the base resolution.

8. The method of claim 1, wherein the selected target scaling process comprises an upscaling process performed in the user device that upscales video data generated at a base resolution using a selected scaling algorithm associated in the display record with the one or more display properties.

9. The method of claim 1, wherein the display record comprises correlations between display identities and the target scaling processes selected among one or more of an upscaling via a pixel duplication process in the user device, an upscaling via a pixel interpolation process in the user device, and no upscaling in the user device.

10. A video scaling system for a user device, comprising:
a video interface configured to identify one or more display properties from a display device based at least in part on the display device being communicatively coupled to the user device;
a video processor configured to select among target scaling processes for a display output of the user device based at least on processing the one or more display properties against a display record;
the video processor configured to scale the display output in accordance with at least a selected target scaling process; and
the video interface configured to transfer the display output for display on the display device.

11. The video scaling system of claim 10, comprising:
the video interface configured to identify the one or more display properties from the display device by at least retrieving the one or more display properties over a communication link that communicatively couples the user device and the display device.

12. The video scaling system of claim 11, wherein the one or more display properties are indicated in Extended Display Identification Data (EDID).

13. The video scaling system of claim 10, comprising:
the video processor configured to process the one or more display properties against the display record by at least comparing a display device identity received from the display device against the display record comprising a plurality of display device identities correlated to preferred target scaling processes.

14. The video scaling system of claim 10, comprising:
the video processor configured to select among the target scaling processes by at least selecting among at least one of an upscaling process and an upscaling algorithm.

15. The video scaling system of claim 10, comprising:
the video processor configured to select among the target scaling processes by at least selecting among an upscaling process performed in the user device and an upscaling process performed in the display device.

16. The video scaling system of claim 10, wherein the selected target scaling process comprises an upscaling process performed in the user device that upscales video data generated at a base resolution in the user device to an upscaled resolution for transfer as the display output, wherein the upscaled resolution comprises a greater resolution than the base resolution.

17. The video scaling system of claim 10, wherein the selected target scaling process comprises an upscaling process performed in the user device that upscales video data generated at a base resolution using a selected scaling algorithm associated in the display record with the one or more display properties.

18. The video scaling system of claim 10, comprising:
the video processor configured to maintain the display record comprising correlations between display identities and the target scaling processes selected among one or more of an upscaling via a pixel duplication process in the user device, an upscaling via a pixel interpolation process in the user device, and no upscaling in the user device.

19. A display output control apparatus for a user device, comprising:
one or more computer readable storage media;
a processing system operatively coupled with the one or more computer readable storage media; and
a graphics scaling service comprising program instructions stored on the one or more computer readable storage media that, based on being read and executed by the processing system, direct the processing system to at least:
based at least in part on a display device being communicatively coupled to the user device, identify one or more display properties from the display device;
select among target scaling processes for a display output of the user device based at least on processing the one or more display properties against a display record;
scale the display output in accordance with at least a selected target scaling process; and
transfer the display output for display on the display device.

20. The display output control apparatus of claim 19, comprising further program instructions, based on being executed by the processing system, direct the processing system to at least:
identify the one or more display properties from the display device by at least retrieving the one or more display properties over a communication link that communicatively couples the user device and the display device, wherein the one or more display properties are indicated in Extended Display Identification Data (EDID); and
select among the target scaling processes by at least selecting among an upscaling process performed in the user device and an upscaling process performed in the display device.
